(19) United States
(12) Patent Application Publication
(10) Pub. No.: US 2026/0054785 A1
(43) Pub. Date: Feb. 26, 2026

(54) HIGH MOBILITY ROBOT WITH WHEELED LIMBS AND PASSIVE SUSPENSION

(71) Applicants: Eagle Technology, LLC, Melbourne, FL (US); Florida State University Research Foundation, Inc., Tallahassee, FL (US)

(72) Inventors: Paul Bosscher, West Melbourne, FL (US); Jonathan Clark, Tallahassee, FL (US); Christian Hubicki, Tallahassee, FL (US)

(21) Appl. No.: 18/809,766

(22) Filed: Aug. 20, 2024

(51) Int. Cl. B62D 57/028; B62D 57/024

(52) U.S. Cl. CPC B62D 57/028; B62D 57/024

(57) ABSTRACT

A mobile platform (MP) and method for operating same. The MP comprising: a chassis which extends in a longitudinal direction from a back end to a front end and extends in lateral directions from a centerline to two opposing lateral sides (wherein the chassis comprises body parts configured to rotate); limbs coupled to chassis (wherein each limb comprises an upper limb member, a lower limb member, a first mechanical joint provided at a first point of articulation between the chassis and the upper limb member, and a second mechanical joint provided at a second point of articulation where the upper limb member meets the lower limb member); and wheels connected to the limbs. Each lower limb member has a first wheel connected to a first end and a second wheel connected to an opposing second end. The second mechanical joint may be located between the first and second wheels.

### BACKGROUND

### Description of the Related Art

Unmanned ground vehicles (UGVs) are being used for an increasing number of tasks, including those involving site security, inspection, emergency response, law enforcement and intelligence/surveillance and reconnaissance (ISR). Consequently, mission objectives for UGVs can involve numerous operational requirements, many of which can be conflicting in nature. For example, UGVs should be highly mobile to not only facilitate mobility on obstacles and irregular terrain (e.g., climbing stairs) and small enough to fit into tight areas (e.g. going through doors and small stairwells), but also have the ability to carry heavy payloads for extended periods of time.

### SUMMARY

This document concerns mobile platform(s). The mobile platform(s) comprise(s): a chassis which extends in a longitudinal direction from a back end to a front end and extends in lateral directions from a platform centerline to two opposing lateral sides, the chassis comprising a plurality of body parts configured to rotate relative to each other; a plurality of limbs coupled to the chassis (wherein each limb of said limbs comprises an upper limb member, a lower limb member, a first mechanical joint provided at a first point of articulation between the chassis and the upper limb member, and a second mechanical joint provided at a second point of articulation where the upper limb member meets the lower limb member); and a plurality of wheels connected to the plurality of limbs. Each lower limb member has a first wheel connected to a first end thereof and a second wheel connected to an opposing second end thereof. The second mechanical joint may be located between the first and second wheels.

This document also concerns method(s) for controlling or operating a mobile platform. The method(s) comprise(s): (i) causing, by a circuit, the mobile platform to traverse terrain; (ii) allowing rotation of a plurality of body parts of the chassis as the mobile platform traverses the terrain (wherein the chassis extends in a longitudinal direction from a back end to a front end and extends in lateral directions from a platform centerline to two opposing lateral sides); (iii) actuating, by the circuit, a first mechanical joint provided at a first point of articulation between the chassis and an upper limb member of a limb of a plurality of limbs coupled to the chassis; and (iv) actuating, by the circuit, a second mechanical joint provided at a second point of articulation where the upper limb member meets a lower limb member of the limb. Operation (i) can involve actuating at least one of a first wheel connected to a first end of the lower limb member and a second wheel connected to an opposing second end of the lower limb member. The second mechanical joint may be located between the first and second wheels.

### BRIEF DESCRIPTION OF THE DRAWINGS

This disclosure is facilitated by reference to the following drawing figures, in which like numerals represent like items throughout the figures, and in which:

FIG. 1 is an illustration of a system having a mobile platform.

FIG. 2 is an illustration of the mobile platform of FIG. 1.

FIG. 3 is another illustration of the mobile platform shown in FIGS. 1-2.

FIG. 4 is another illustration of the mobile platform shown in FIGS. 1-2.

FIG. 5 provides an illustration that is useful for understanding movement of the mobile platform shown in FIGS. 1-4.

FIG. 6 provides an illustration showing movement of the mobile platform over hilly terrain while maintaining the elongate length of the chassis aligned with a central axis.

FIG. 7 provides an illustration showing movement of the mobile platform over stepped terrain.

FIG. 8 provides an illustration that is useful for understanding the off-road driving mode of the mobile platform.

FIGS. 9A-9B (collectively referred to as “FIG. 9”) provide illustrations that are useful for understanding the wheel tumbling mode of the mobile platform.

FIG. 10 provides an illustration that is useful for understanding the walking mode of the mobile platform.

FIG. 11 provides an illustration that is useful for understanding the climbing or whole-body maneuvering mode of the mobile platform.

FIGS. 12A-12B (collectively referred to as “FIG. 12”) provide illustrations showing the mobile platform in a fully upright position and in an upright and outstretched position.

FIG. 13 provides an illustration that is useful for understanding turning of the mobile platform.

FIG. 14 provides an illustration that is useful for understanding a part interchangeability feature of the mobile platform.

FIG. 15 provides an illustration showing an offset position a mechanical joint between the upper and lower members of a limb of the mobile platform.

FIG. 16 provides a flow diagram of an illustrative method for operation and/or controlling a mobile platform.

FIG. 17 provides a block diagram of an illustrative computing device.

### DETAILED DESCRIPTION

It will be readily understood that the components of the systems and/or methods as generally described herein and illustrated in the appended figures could be arranged and designed in a wide variety of different configurations. Thus, the following more detailed description, as represented in the figures, is not intended to limit the scope of the present disclosure, but is merely representative of certain implementations in various different scenarios. While the various aspects are presented in the drawings, the drawings are not necessarily drawn to scale unless specifically indicated.

Unmanned ground vehicles (UGVs) need to be able to perform a variety of different tasks and operations without becoming unstable and tipping over. Various conventional approaches have been applied to solve this problem. For example, some conventional mobility platforms include wheels and tracks. These mobility platforms have relatively good endurance, payload capacity, speed, and mobility over different surfaces (e.g., mud and snow). However, they have relatively poor mobility on obstacles and in unstructured terrain. Other conventional mobility platforms include legs. These mobility platforms have relatively good mobility over different surfaces (e.g., mud and snow), on obstacles and in unstructured terrain. However, they have relatively poor endurance, payload capacity and speed. Therefore, current UGVs offer either mobility and agility or endurance and payload capacity, but not both.

The present solution provides a mobility platform implementing a hybrid approach that offers both of these things. In effect, the present solution has relatively good endurance, payload capacity, speed, mobility in mud and snow, and mobility in unstructured terrain. The solution is described below in greater detail.

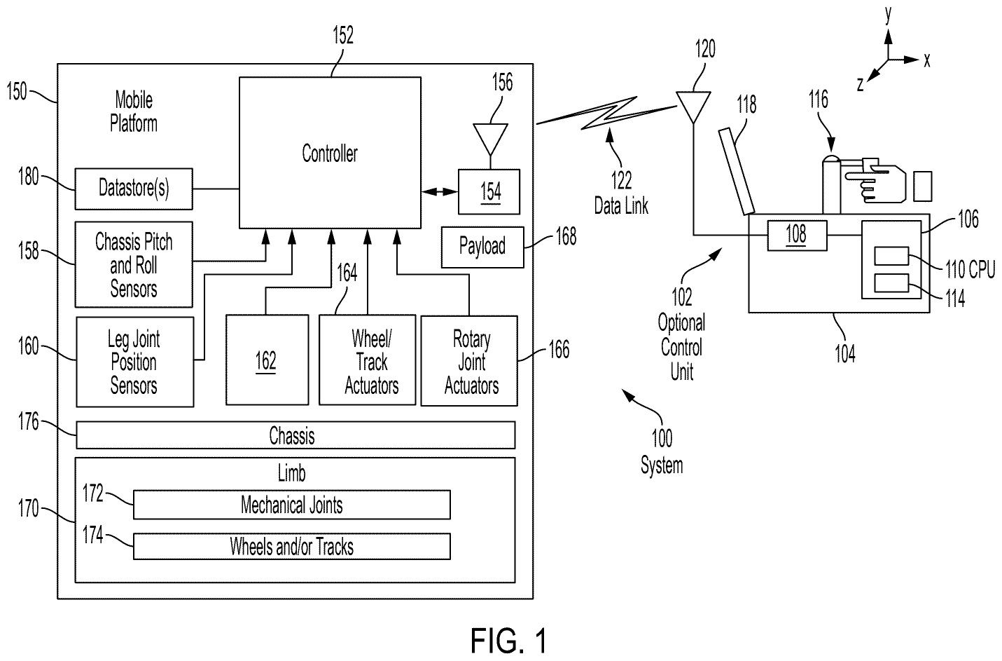

FIG. 1 provides a block diagram showing a system 100 that includes an optional control unit 102 and a mobile platform 150. The illustration of the mobile platform 150 and control unit 102 is not drawn to scale. For example, the mobile platform 150 can be significantly larger than the control unit 102. However, FIG. 1 is sufficient for understanding the present solution, and relationship between the two electronic components 102 and 150.

The mobile platform 150 is a motorized vehicle that operates without an on-board human presence. The mobile platform 150 can be used in various applications, such as site security applications, inspection applications, search and rescue applications, emergency response applications, and/or ISR applications. The mobile platform 150 can include, but is not limited to, a UGV. The UGV can be used to, for example, transport a payload 168 to a particular destination location. The payload 168 can include, but is not limited to, an articulating arm. The mobile platform 150 may be configured to be autonomous, semi-autonomous, and/or remotely controllable via the control unit 102. A data link 122 (e.g., a wireless data link) allows the control system 102 to communicate commands to the mobile platform 150, and allows the control system 102 to receive information from the mobile platform 150. For example, such information can include images from video cameras, haptic feedback data, and other information (e.g., battery related information) pertaining to the operational status of the mobile platform 150.

The control unit 102 can include a user interface control 116, data processing system 106, and a data transceiver 108 to support the data link 122. In some embodiments, user interface control 116 can sense hand movement along two or three linear directions of motion defined by orthogonal axes x, y and z. In this regard, the user interface control 116 can include, but is not limited to, a joystick. Forward movement of the joystick may cause forward movement of the mobile platform 150, while backward movement of the joystick may cause backward movement of the mobile platform 150. Right-side movement of the joystick may cause the mobile platform 150 to turn right, while left-side movement of the joystick may cause the mobile platform 150 to turn left. The present solution is not limited to this manner of controlling the mobile platform's movement. Any known or to be known vehicle motion control technique can be used herein.

Data processing system 106 includes a data processing hardware element 110. The data processing element 110 can include, but is not limited to, a central processing unit (CPU) and/or an Application Specific Integrated Circuit (ASIC). The data processing system 106 can also include a memory or data storage device 114 for storing a set of instructions (e.g., software code). The instructions implement one or more of the methodologies, procedures, or functions described herein. The instructions can also reside, completely or at least partially, within the data processing element 110 during execution thereof thereby. The data processing element 110 and memory or data storage device 114 also can constitute machine-readable media.

The data processing system 106 may be fully integrated with the user interface control 116. For example, the data processing system 106 could be integrated into a base 104 associated with the user interface control 116. The data processing system 106 can be operatively connected to a display unit 118 for purposes of displaying video images. The display unit 118 may be integrated with the control system 106 as shown or separate from the control system 106.

Data transceiver 108 is operatively coupled to the data processing system 106. The data transceiver 108 can include any type of wired or wireless transceiver suitable for communicating data to and from a data transceiver 154 of the mobile platform 150. If data transceivers 108, 154 are wireless devices then antennas 120, 156 can be respectively coupled to the data transceivers. A suitable wireless data link interface can be based on any of a variety of well-known wireless interface standards. Examples of such well known wireless interface standards can include the Bluetooth wireless standard, and the IEEE 802.11 family of standards. However, the invention is not limited in this regard and any other wireless interface standard can be used. Data communicated over the data link 122 can include motion control commands directed to mobile platform 150, feedback data communicated from mobile platform 150 to the data processing system 106, and video data communicated from the mobile platform 150 to the data processing system 106.

The mobile platform 150 is a robot system capable of performing moving actions based on commands generated by an onboard controller 152 and/or telematic commands received from remote control unit 102. Onboard controller 152 includes circuitry for generating motion control commands, processing received motion control commands, and/or communicating feedback data to the control unit 102. The circuitry of the onboard controller 152 can include, but is not limited to, microprocessor(s), microcontroller(s), and/or ASIC(s). The circuitry of the onboard controller 152 is communicatively connected to datastore(s) 180 for accessing instructions and/or data useful for controlling operations of the mobile platform 150. The on-board controller 152 is also configured to perform communication operations involving data transceiver 154.

With reference to FIGS. 1-3, mobile platform 150 includes a chassis 176 with four limbs 170₁, 170₂, 170₃, 170₄ (collectively referred to as limbs 170) coupled thereto. Chassis 176 comprises body parts 210, 212 and 214 that are coupled to each other. Although three body parts are shown in the drawings, the mobile platform can include any number of body parts selected in accordance with a given application. For example, the mobile platform can include two body parts rather than three body parts as shown.

Each body part 210, 212 and 214 is configured to be rotatable or twist about a platform centerline or axis 250 independent and separate from any rotation of the other body parts. The rotation of the body part can be passive or actively controlled by controller 152 and/or control unit 102. The rotating or twisting of the body parts facilitates the prevention of side-toppling of the mobile platform on uneven terrain. The rotation or twisting of the body parts can be achieved using, for example, spring(s) and/or damper(s) on each rotary joint 260, 262 between two adjacent body parts. Machine learning algorithm(s) or model(s) can be used to autonomously control movement of the body parts relative to each other and relative to limb movements to reduce the likelihood of the mobile platform tipping over during operations. The machine learning algorithm(s) or model(s) can include, but are not limited to, neural networks.

Each body part 210, 212 and 214 can rotate or pivot N° or less around an axis 250. N is any number between 1 and 360 selected in accordance with a given application. The body parts can be selectively configured at any time to rotate or pivot around axis 250 by the same amount or by different amounts. For example, at a first time, all body parts are configured to rotate N° around an axis 250. However, at a second time, body part 210 is configured to rotate N₁° around an axis 250, while body part 212 is configured to rotate N₂° around an axis 250. N₁ is not equal to N₂. Additionally or alternatively, the amount by which each body part rotates about axis 250 can be changed, modified or otherwise adjusted during operation of the mobile platform based on sensor data and/or certain criteria. For example, N is changed from a first value to a different second value based on a change in one or more characteristics of the surrounding environment and/or terrain over which the mobile platform is traveling.

Axis 250 extends from a front end 230 of the chassis 176 to a backend 232 of the chassis 176. Chassis pitch and roll sensors 158 provide chassis pitch and roll angle information to the controller 152 for use in controlling movement of the limbs 176 and/or body parts 210-214.

Each limb 170₁, 170₂, 170₃, 170₄ has one or more mechanical joints 172. For example, limb 170₁ comprises mechanical joints 172₁₋₁, 172₁₋₂. Limb 170₂ comprises mechanical joints 172₂₋₁, 172₂₋₂. Limb 170₃ comprises mechanical joints 172₃₋₁, 172₃₋₂. Limb 170₄ comprises mechanical joints 172₄₋₁, 172₄₋₂.

Each mechanical joint 172₁₋₁, 172₂₋₁, 172₃₋₁, 172₄₋₁ is provided at the point of articulation between the chassis 176 and the respective upper limb member 206. At this point of articulation, a proximal end 230 of the mechanical joint is rotably or pivotably coupled to the chassis 176 via a coupling means 234. Coupling means 234 can include, but is not limited to, an axel, a pin, a shaft, gear(s), and/or a ball and socket. The upper limb member 206 can rotate 360° or less around an axis 252 which extends through this point of articulation. In this regard, an elongate body of the upper limb member 206 may extend parallel to axis 250 at a first time, extend perpendicular to axis 250 at a second time, and otherwise extend in a direction that is angled relative to axis 250 at a third time.

Each mechanical joint 172₁₋₂, 172₂₋₂, 172₃₋₂, 172₄₋₂ is provided at a point of articulation where the respective upper limb member 206 meets the respective lower limb member 208. At this point of articulation, a distal end 232 of the upper limb member 206 is rotatably or pivotably coupled to the lower limb member 208 via a coupling means 242. Coupling means 242 can include, but is not limited to, an axel, a pin, a shaft, gear(s), and/or a ball and socket.

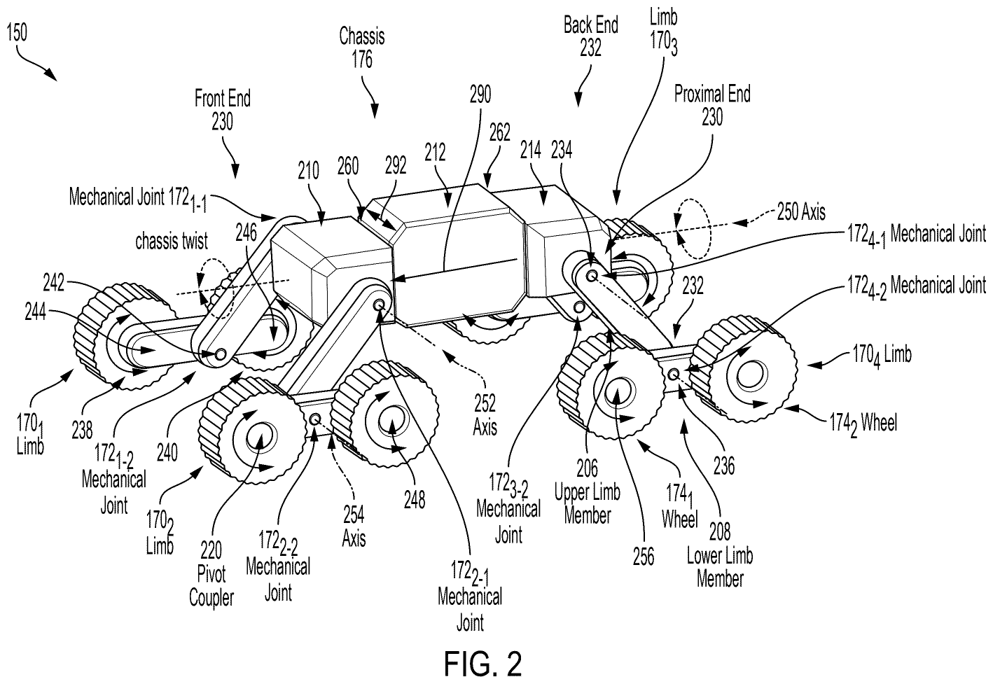

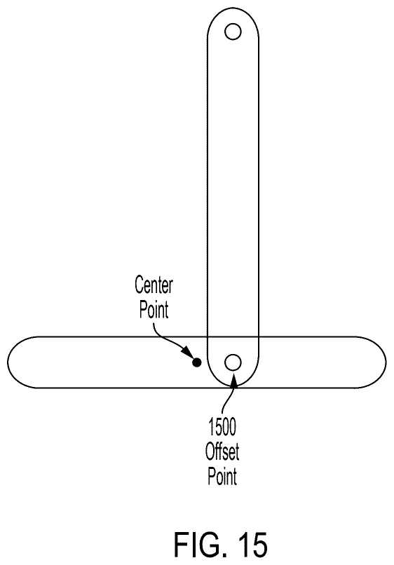

In the scenario shown in FIG. 2, the distal end 232 of the upper limb member 206 is rotatably or pivotably coupled to a center 236 of the lower limb member 208. Thus, a first half 238 of the lower limb member 208 resides on one side of this point of articulation, while a second half 240 of the lower limb member 208 resides on the opposite side of this point of articulation. The present solution is not limited in this regard. As shown in FIG. 15, the distal end of the upper limb member is rotatably or pivotably coupled to the lower limb member at a point 1500 that is offset from center.

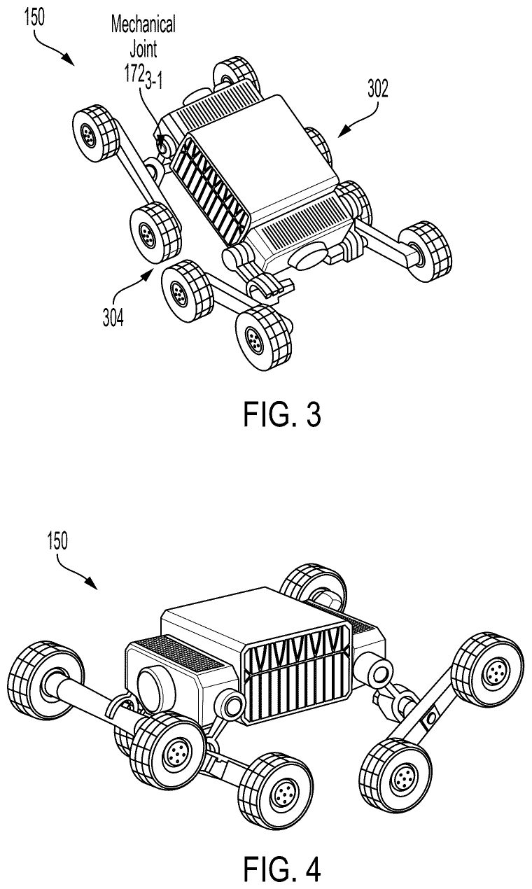

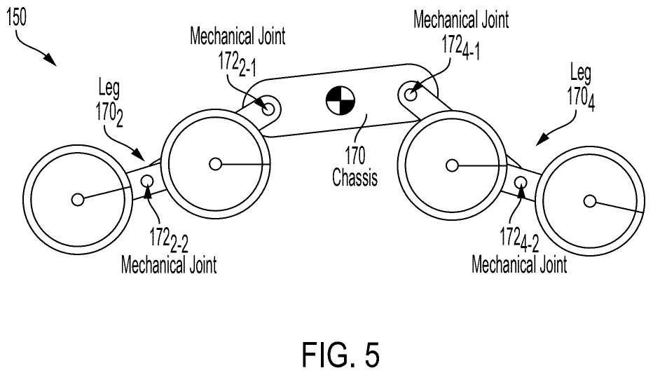

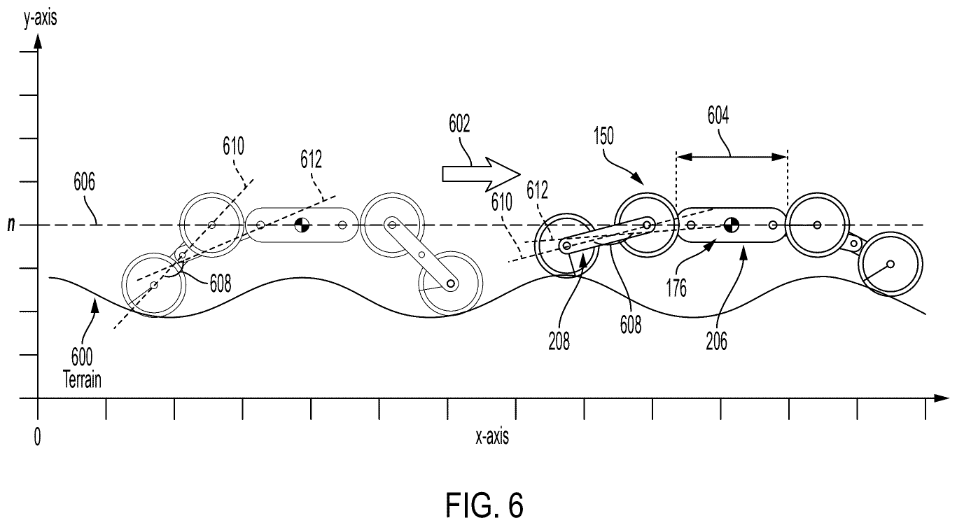

The lower limb member 208 can rotate M° around an axis 254 which extends through this point of articulation. M is any number between 1 and 360. The lower limb member 208 may be configured for continuous, unlimited rotation in both of two opposing direction. If M is 360 or 180, then an elongate body of the lower limb member 208 may extend parallel to axis 250 at a first time, extend perpendicular to axis 250 at a second time, and otherwise extend in a direction that is angled relative to axis 250 at a third time. Illustration are provided in FIGS. 3-5 which show different relative positions of the mechanical joints due to rotations thereof.

Movement of the mechanical joints 172 is controlled by controller 152 and/or control unit 102. Rotary joint actuators 166 are provided to facilitate movement of the limbs 170 in accordance with motion control command signals. The rotary joint actuators 166 can include, but are not limited to, servo motors. Limb joint position sensors 160 provide position information with regard to one or more of the mechanical joints 172. This position information is communicated from the limb joint position sensors 160 to the controller 152 and/or the control unit 102. A limb joint position sensor can be provided at each mechanical joint 172₁₋₁, 172₂₋₁, 172₃₋₁, 172₄₋₁, 172₁₋₂, 172₂₋₂, 172₃₋₂, 172₄₋₂.

The mobile platform 150 also includes other movable elements in the form of wheels and/or tracks 174. In FIG. 2, each limb 170₁, 170₂, 170₃, 170₄ of the mobile platform 150 comprises at least two wheels 174₁, 174₂ pivotally connected thereto via couplers 256. Couplers 256 can include, but are not limited to, axels, pins, shafts, and/or gears. A first wheel 174₁ is located at a first end 244 of the lower limb member 208, while a second wheel 174₂ is located at an opposing second end 246 of the lower limb member 208. Each wheel 174₁, 174₂ can rotate 360° in two opposing directions around a respective wheel pivot point 248. Each wheel 174₁, 174₂ may be configured for unlimited rotation in both of two opposing direction.

The mobile platform 150 further comprises wheel/track actuators 164. The wheel/track actuators 164 can include, but are not limited to, variable-speed, reversible electric motors mounted inside the chassis 176. One or both of the wheels per limb can be actively rotated via the wheel/track actuators 164. In one scenario, one of the wheels per limb can rotated freely while rotated of the other one of the wheels of the same limb is actively controlled by a wheel/track actuator 164. In another scenario, rotation of both wheels of each limb is actively controlled by the wheel/track actuators 164. One of the actuators 164 may be coupled to wheel 174₁ so that activation of this motor causes wheel 174₁ to rotate. Another one of the actuators 164 may be coupled to the rear wheel 174₂ so that activation of this motor causes the wheel 174₂ to rotate. Movement of the wheels 174₁, 174₂ by actuators 164 may be controlled by movement command signals from controller 152 and/or control unit 102.

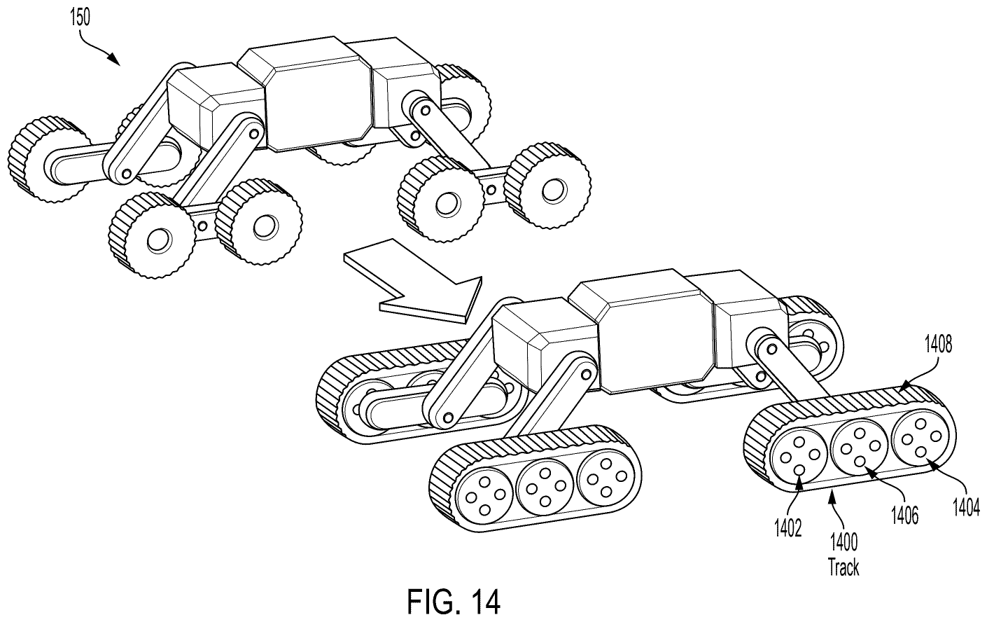

The wheels 174₁, 174₂ may be optionally replaced or interchanged with a track 1400 as shown in FIG. 14. Track 1400 comprises wheels 1402, 1404, 1406 coupled by way of a tread 1408. Rotation of wheel 1202 and/or wheel 1204 drives the tread 1408, which in turn causes the center wheel 1406 to rotate. Movement of the wheel(s) 1402, 1404 may be controlled by movement command signals from controller 152 and/or control unit 102. The tracks 1400 allow the mobile platform to be selectively configured for improved operation in soft soil, mud and/or snow.

Other sensors 162 may be provided with the mobile platform 150 to indicate movement of the wheels 174, 1406. Sensors 162 can include, but are not limited to, optical encoders, magnetic encoders, potentiometers, and resolvers. The outputs from the sensors 162 may be used by the controller 152 and/or control unit 102 for controlling movements of the mobile platform 150. Sensors 162 may also include environmental sensors, camera(s), a lidar system, and/or a radar system. These sensors can be used to detect characteristics of a surrounding environments and/or detect objects in proximity to the mobile platform 150. Any known or to be known object detection technique can be used here.

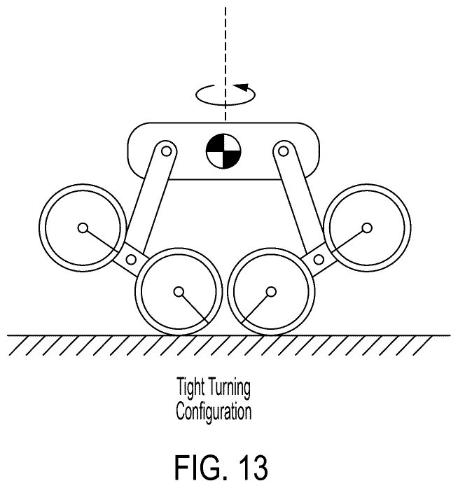

The position of the mobile platform 150 is controlled through the selective activation and deactivation of the actuators 164 in response to control inputs generated by controller 152 and/or control unit 102. Linear or straight-line travel of the mobile platform 150 is effectuated by the simultaneous activation of actuators 164 in the same direction and at the same speed so as to drive wheels and tracks 174 in the same direction and at the same speed. Turning of the mobile platform 150 can be achieved by: (1) simultaneously activating the actuators for wheels of the limbs 170₁, 170₂ on a first side of the mobile platform 150 and actuators for wheels of the limbs 170₂, 170₄ on a second side of the mobile platform 150 in opposite directions or in the same direction at different speeds; (2) operating actuators for only one of the limbs; (3) rotating mechanical joints 172₁₋₂, 17₂₋₂, 172₃₋₂, 172₄₋₂ such that the outermost wheel (e.g., wheels 174₂) of each limb is raised off the ground and the innermost wheel (e.g., wheels 174₁) of each limb remains in contact with the ground (as shown in FIG. 13) and then simultaneously activating the actuators for innermost wheels of the limbs 170₁, 170₂ on a first side of the mobile platform 150 and actuators for the innermost wheels of the limbs 170₂, 170₄ on a second side of the mobile platform 150 in opposite directions or in the same direction at different speeds; or (4) rotating mechanical joints 172₁₋₂, 17₂₋₂, 172₃₋₂, 172₄₋₂ such that the outermost wheel (e.g., wheels 174₂) of each limb is raised off the ground and the innermost wheel (e.g., wheels 174₁) of each limb remains in contact with the ground (as shown in FIG. 13) and then operating actuators for only one of the limbs.

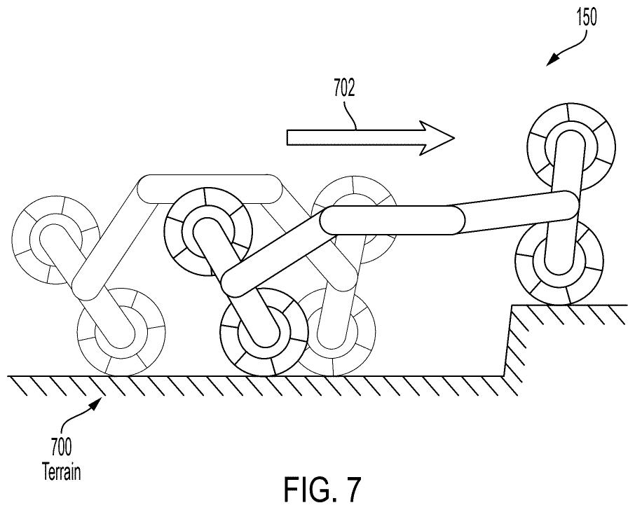

FIG. 6 provides an illustration showing movement of the mobile platform 150 over hilly terrain 600 while maintaining the central axis 250 and elongate length 604 of the chassis 176 aligned with a reference line 606 extending horizontally relative to an x-axis and having a constant value n on an y-axis. The x-axis can be referred as the horizontal axis, while the y-axis can be referred to as the vertical axis. Arrow 602 represents the mobile platform's direction of travel. This is achieved by continuously adjusting the relative positions of the mechanical joints 172 of the four limbs 170 responsive to changes in elevation and/or elevated slope of the terrain 600. As the terrain's elevation increases, the angle 608 between an elongate central axis 610 of lower limb member 208 and an elongate central axis 612 of the upper limb member 206 increases as seen in FIG. 6. As the terrain's elevation decreases, the angle 608 between an elongate central axis 610 of lower limb member 208 and an elongate central axis 612 of the upper limb member 206 decreases as also seen in FIG. 6.

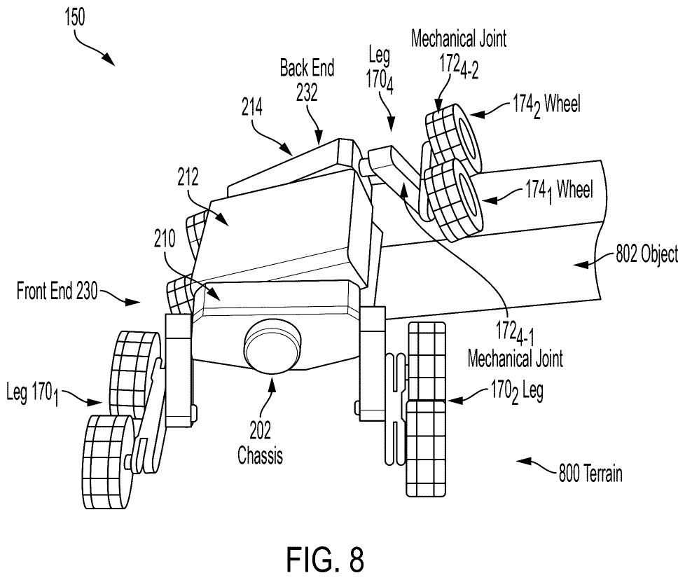

FIG. 7 provides an illustration showing movement of the mobile platform 150 over stepped terrain 700. Arrow 702 represents the mobile platform's direction of travel.

The combination of wheels and jointed limbs enables a variety of operational modes for the mobile platform 150. These operational modes can include, but are not limited to, a road driving mode, an off-road driving mode, a wheel tumbling mode, a walking mode, and a climbing or whole body maneuvering mode. These operational modes provide the mobile platform with an increased battery life as compared to conventional mobile platforms, relatively higher energy efficiency as compared to conventional mobile platforms, the ability to carry relatively heavier payloads as compared to conventional mobile platforms, a relatively simpler control system as compared to conventional mobile platforms, and an ability to climb obstacles that conventional mobile platforms cannot traverse.

The mobile platform can switch between modes responsive to user-software interaction via the control unit 102 and/or autonomously based on sensor data obtained by sensors 162 thereof. For example, the mobile platform 150 can switch from the road driving mode to the wheel tumbling mode when an analysis of the sensor data indicates that stairs reside in the path of travel of the mobile platform. The mobile platform 150 can switch from the road driving mode to the climbing mode when a relatively tall obstruction resides in the path of travel of the mobile platform. The present solution is not limited to the particulars of these examples.

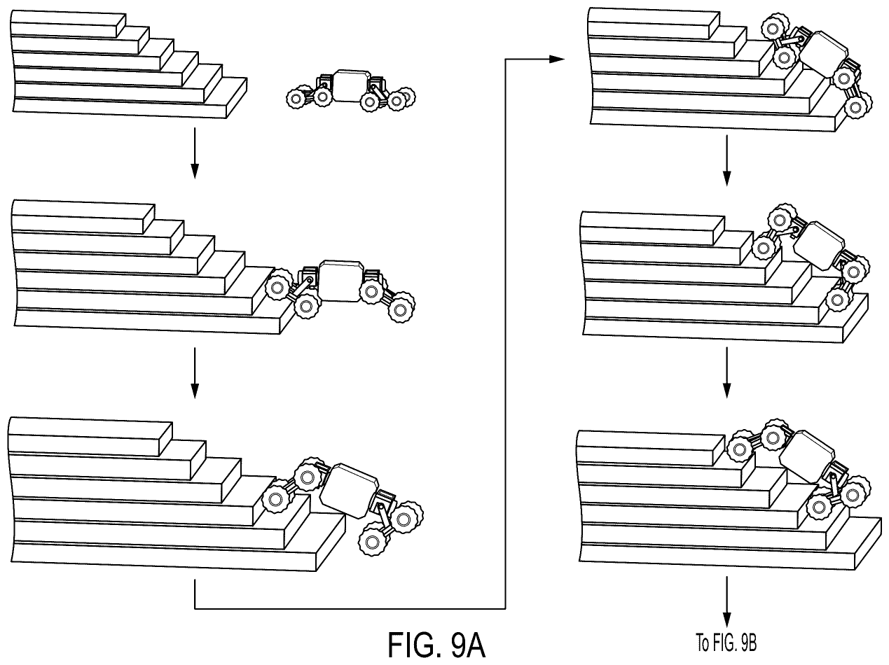

FIG. 8 provides an illustration that is useful for understanding the off-road driving mode of the mobile platform 150. The mobile platform 150 is traveling over terrain 800 with an object 802 in the path of travel thereof. The limbs 170 and chassis 176 perform movements to traverse the object 802. These movements can include, but are not limited to, rotation of wheels 174, rotation of each limb's mechanical joint(s) 172, and the twisting of the chassis body parts 210-214. In this mode, the rotary joint actuators 166 associated with the upper mechanical joints 172₁₋₁, 172₂₋₁, 172₃₋₁, 172₄₋₁ may be locked so as to maintain the upper mechanical joints at fixed angles, while the rotary joint actuators 166 associated with the lower mechanical joints 172₁₋₂, 172₂₋₂, 172₃₋₂, 172₄₋₂ are allowed to freely spin or otherwise rotate. The wheel actuators are actively controlled to spin or otherwise rotate the wheels 174. The advantages of the off-road mode include, but are not limited to, high energy efficiency since the rotary joint actuators 166 do not draw power, and/or the provision of suspension by the flex of the upper and lower mechanical joints 172 which facilitates improved mobility on moderate terrain.

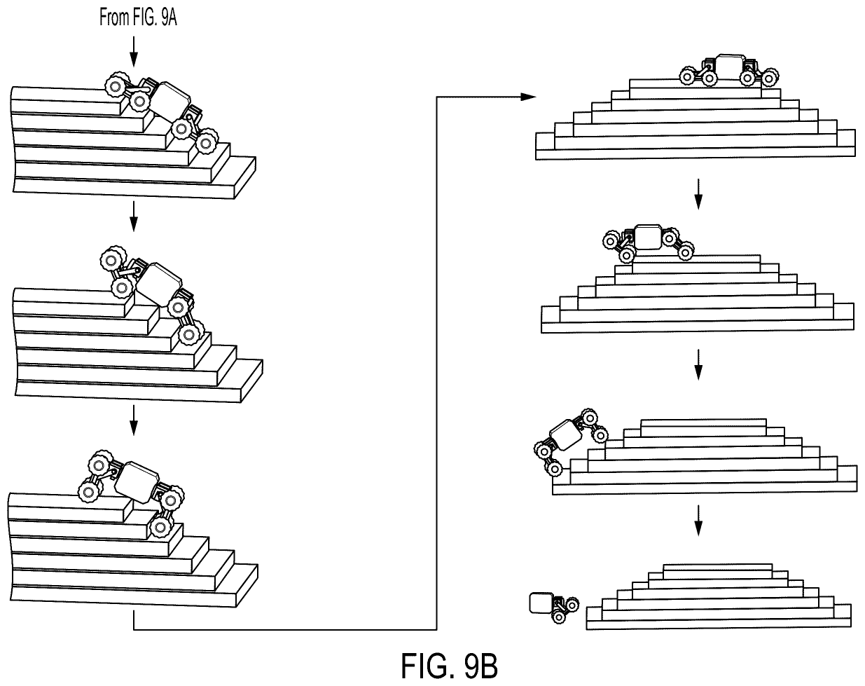

FIG. 9 provides illustrations that are useful for understanding the wheel tumbling mode of the mobile platform 150. The mobile platform 150 is traveling over terrain 800 with an object 802 in the path of travel thereof. The limbs 170 and chassis 176 perform movements to traverse the object 802. These movements can include, but are not limited to, rotation of wheels 174, rotation of each limb's mechanical joint(s) 172, and the twisting of the chassis body parts 210-214. This operational mode involves: locking the rotary joint actuators 166 associated with the upper mechanical joints 172₁₋₁, 172₂₋₁, 172₃₋₁, 172₄₋₁ so as to maintain the upper mechanical joints at fixed angles; configuring the wheel and/or track actuators 164 to remain stationary or only be allowed relatively small or minor rotation; and configuring the rotary joint actuators 166 to allow for continuous rotation of the lower mechanical joints 172₁₋₂, 172₂₋₂, 172₃₋₂, 172₄₋₂. The advantages of the off-road mode include, but are not limited to, high energy efficiency since the rotary joint actuators 166 associated with the upper mechanical joints do not draw power, allowing relatively heavy payloads to be carried by the mobile platform due to the low speed and high torque of the lower mechanical joints, and allowing for a relatively simple movement control system since there is no requirement for relatively complex footsteps to be made by the mobile platform.

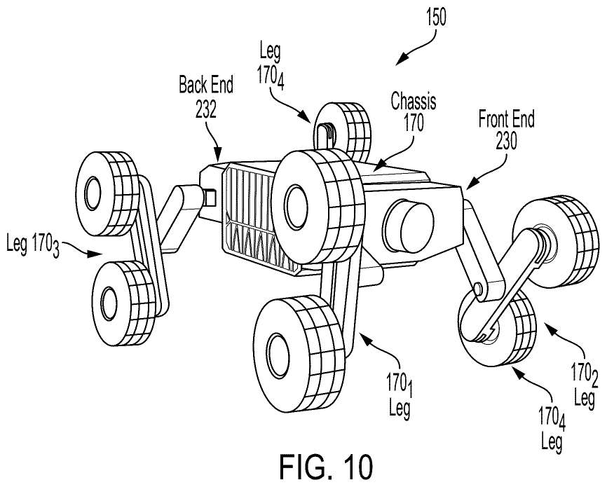

FIG. 10 provides an illustration that is useful for understanding the walking mode of the mobile platform 150. This mode involves: raising one wheel per limb off the ground; preventing the lifted limbs from coming in contact with the ground; configuring the rotary joint actuators 166 associated with the upper and lower mechanical joints to be active for enabling stepping over objects; and/or configuring the wheel and/or track actuators 164 to be active for enabling spinning of the wheels, steering and/or turning. The advantages of the walking mode include, but are not limited to, the provision of mobility of walking by the mobile platform, and the provision of novel behaviors by the mobile platform. The novel behaviors include, but are not limited to, switching mid-stride which wheel of a limb is to be in contact with the ground.

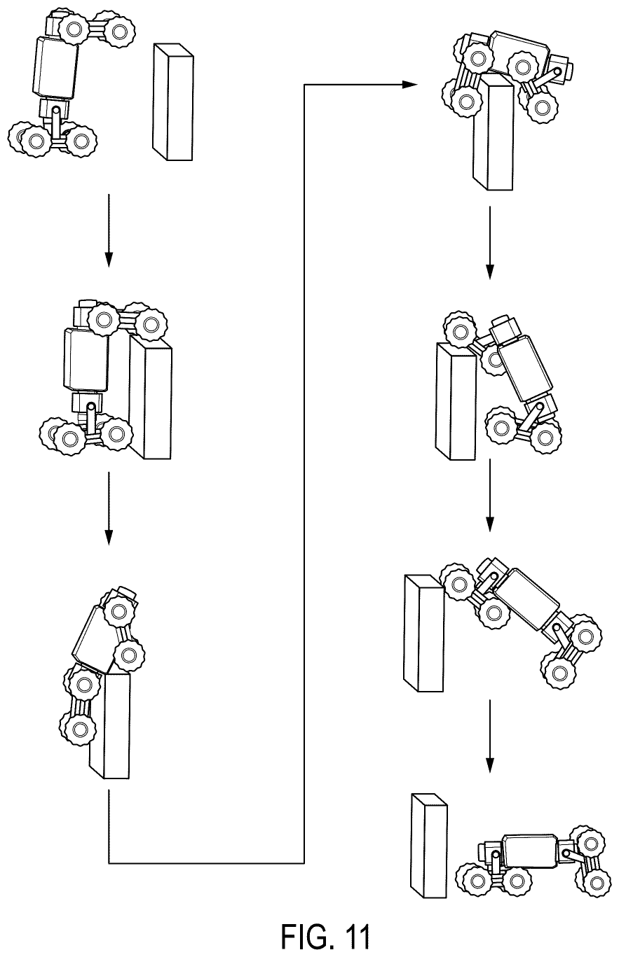

FIG. 11 provides an illustration that is useful for understanding the climbing or whole-body maneuvering mode of the mobile platform 150. This mode involves: combined use of all the mechanical joints 172 of the limbs 170 and chassis 176; and complex behaviors that may be autonomously synthesized by the controller 152. The advantages of the climbing or whole-body maneuvering mode include, but are not limited to, the provision of an ability to climb obstacles that cannot be traversed by existing mobile platforms.

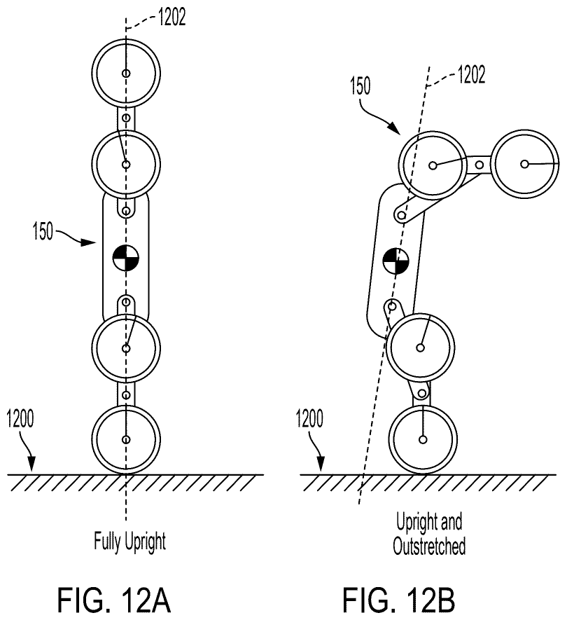

FIG. 12 provides illustrations showing other positions that the mobile platform 150 can have as a result of actuation of the mechanical joints 172 of the limbs 170. The mobile platform 150 can be placed in a position in which center axis of the limbs 170 and chassis 176 are aligned with each other so that the mobile platform extends fully upright or vertical relative to ground 1200 as shown in FIG. 12A. In the fully upright or vertical position, the limbs and wheels on a first end (e.g., front end) of the mobile platform are raised in the air and arranged so as to be aligned with the limbs and wheels on a second end (e.g., back end) of the mobile platform adjacent to ground 1200. The elongate center axis 122 of the chassis extend perpendicular to ground.

The mobile platform 150 is configured to adjust its overall shape to counterbalance changes in weight distribution when limb(s) at least partially extend(s) horizontal to the ground 1200 as shown in FIG. 12B. This feature of the mobile platform facilitates transitioning of the mobile platform to/from the upright position shown in FIG. 12A and to/from at least partially upright positions (such as that shown in FIG. 12B) without overturning.

The mobile platform 150 has many novel features. These novel features include, but are not limited to: (i) an ability to have multiple modes of locomotion (e.g., rolling with passive suspension, tumbling wheel pairs, walking, and whole-body climbing); and (ii) an ability to achieve combinations of mobility, endurance and payload capacity. With regard to feature (ii), the off-road driving of the mobile platform with wheels is high energy-efficient which results in a significant improvement in system endurance as compared to conventional legged mobile platform. The passive suspension elements and large ground contact patch allows the mobile platform to outperform legged platforms with wheels. The mobile platform is able to carry significant loads because of the primary mobility mode is wheels driving rather than walking. Carrying heavy loads does not meaningfully impact system endurance. The advanced mobility modes (e.g., tumbling mode, walking mode, and climbing mode) provide the mobile platform with the ability to traverse a wide range of obstacles. These operations modes allow the mobile platform to outperform conventional wheeled and tracked systems.

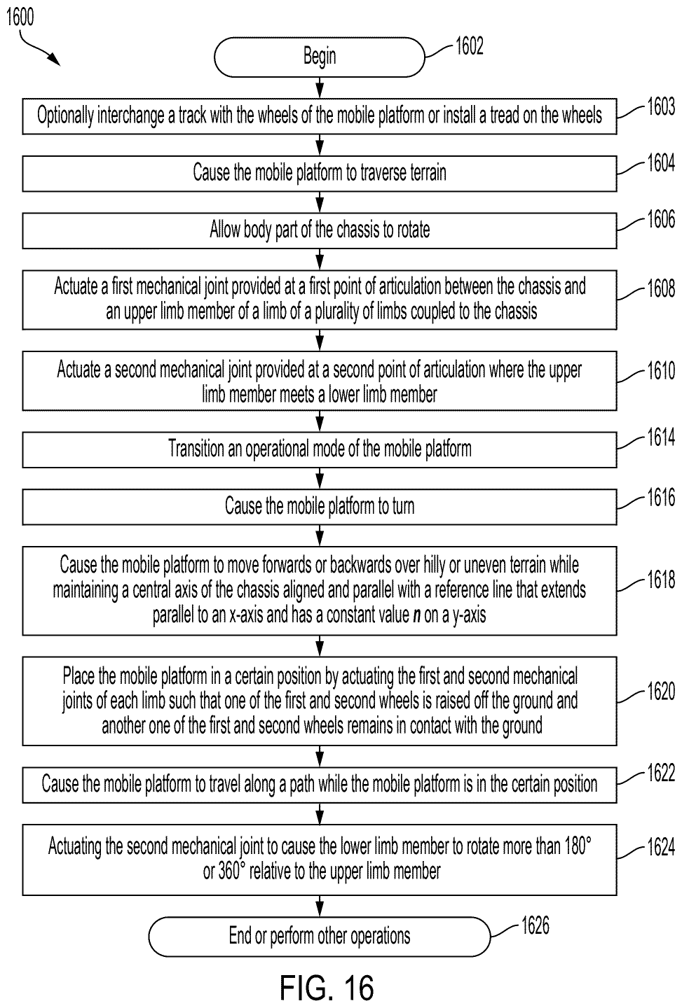

FIG. 16 provides a flow diagram of an illustrative method 1600 for controlling or otherwise operating a mobile platform (e.g., mobile platform 150 of FIGS. 1-2). Method 1600 begins with 1602 and continues with 1603 where the first and second wheels are optionally interchanged with a track (e.g., track 1400 of FIG. 14) or a tread (e.g., tread 1408 of FIG. 14) is installed on the wheels.

In 1604, a circuit (e.g., control unit 102, controller 152, actuators 164, transceiver 154, and/or wheels and/or tracks 174 of FIG. 1) cause the mobile platform to traverse terrain (e.g., terrain 600 of FIGS. 6, 700 of FIG. 7, and/or 800 of FIG. 8,) . This may be achieved, for example, by causing the mobile platform to traveling forwards or backwards. Movement of the mobile platform can involve actuating at least one of a first wheel (e.g., wheel 174₁ of FIGS. 1-2) connected to a first end (e.g., end 238 of FIG. 2) of a lower limb member (e.g., lower limb member 208 of FIG. 2) and a second wheel (e.g., wheel 174₂ of FIG. 2) connected to an opposing second end (e.g., end 240 of FIG. 2) of the lower limb member. Actuation of the first wheel is performed independent of actuation of the second wheel. Additionally or alternatively, the first and second wheels may be actuated simultaneously as a pair of wheels.

In 1606, a plurality of body parts (e.g., body parts 210, 212 and/or 214 of FIG. 2) of the chassis (e.g., chassis 176 of FIGS. 1-2) are allowed to rotate as the mobile platform traverses the terrain. The body parts may include, but are not limited to, a front body part, a back body part, and/or a center body part rotatably coupled between the front and back body part. The chassis extends in a longitudinal direction (e.g., direction 290 of FIG. 3) from a back end (e.g., back end 232 of FIG. 2) to a front end (e.g., front end 230 of FIG. 30 and extending in lateral directions (e.g., lateral directions 292 of FIG. 2) from a platform centerline (e.g., centerline 250 of FIG. 2) to two opposing lateral sides (e.g., sides 302, 304 of FIG. 3). Each body part rotates around a center axis (e.g., axis 250 of FIG. 2) that extends from the back end of the chassis to the front end of the chassis. The body parts may be configured to rotate in the same direction and different directions relative to each other at any given time. The rotation of the body parts can be passive or active. In the active scenarios, the circuit performs operations to actuate a rotary joint provided between two adjacent body parts. Any known or to be known rotary joint can be used here.

In 1608, the circuit performs operations to actuate a first mechanical joint (e.g., mechanical joint 172₁₋₁, 172₂₋₁, 172₃₋₁, 172₄₋₁ of FIG. 2) provided at a first point of articulation between the chassis and an upper limb member (e.g., upper limb member 206 of FIG. 2) of a limb (e.g., limb 170₁, 170₂, 170₃ or 170₄ of FIGS. 1-2) coupled to the chassis. The circuit also performs operations in 1610 to actuate a second mechanical joint (e.g., mechanical joint 172₁₋₂, 172₂₋₂, 172₃₋₂, 172₄₋₂ of FIG. 2) provided at a second point of articulation where the upper limb member meets a lower limb member (e.g., lower limb member 208 of FIG. 2). The second mechanical joint is located between the first and second wheels. For example, the second mechanical joint is located midway between the first and second wheels. The first mechanical joint rotates about a first axis (e.g., axis 252 of FIG. 2). The second mechanical joint rotates about a second axis (e.g., axis 254 of FIG. 2) that is parallel to the first axis.

The operations of 1608-1610 may be performed for each limb of the mobile platform. In some scenarios, four limbs are provided with the mobile platform. A first limb and a second limb are coupled to the front end of the chassis on opposing sides of the mobile platform, and a third limb and a fourth limb are coupled to the back end of the chassis on the opposing sides of the mobile platform. The present solution is not limited to the particulars of this scenario.

The system transitions an operational mode of the mobile platform in 1614. This transition may be selectively performed based on defined criteria (e.g., tread(s) and/or track(s) has (have) been installed) and/or based on sensed conditions or characteristics of a surrounding environment (e.g., there is hill, stairs, obstacle, mud, snow or ice detected by the mobile platform in the path of travel thereof). The operational modes of the mobile platform include, but are not limited to, a road driving mode, an off-road driving mode, a wheel tumbling mode, a walking mode, and a climbing mode.

In 1616, the circuit causes the mobile platform to turn. Turning of the mobile platform can be achieved by: rotating the first and second mechanical joints such that an outermost wheel (e.g., wheel 174₂ of FIG. 2) of the first and second wheels of each limb is raised off the ground and an innermost wheel (e.g., 174₁ of FIG. 2) of the first and second wheels of each limb remains in contact with the ground; and simultaneously actuating the innermost wheels on a first side of the mobile platform and actuating the innermost wheels on a second side of the mobile platform in opposite directions or in the same direction at different speeds. Turning of the mobile platform can also be achieved by: rotating the first and second mechanical joints such that an outermost wheel of the first and second wheels of each limb is raised off the ground and an innermost wheel of the first and second wheels of each limb remains in contact with the ground; and actuating only one of the innermost wheels.

In 1618, the circuit performs operations to cause an actuation of the first and second mechanical joints of each limb to cause the mobile platform to move forwards or backwards over hilly or uneven terrain (e.g., terrain 600 of FIG. 6) while maintaining a central axis (e.g., axis 250 of FIG. 2) of the chassis aligned and parallel with a reference line (e.g., line 606 of FIG. 6) that extends parallel to an x-axis and has a constant value n on a y-axis.

In 1620-1622, the circuit performs operations to: place the mobile platform in a certain position by actuating the first and second mechanical joints of each limb such that one of the first and second wheels is raised off the ground and another one of the first and second wheels remains in contact with the ground; and cause the mobile platform to travel along a path while the mobile platform is in the certain position.

In 1624, the circuit performs operations to actuate the second mechanical joint to cause the lower limb member to rotate more than 180° or 360° relative to the upper limb member. Subsequently, method 1600 continues with 1626 where it ends or other operations are performed (e.g., return to 1602).

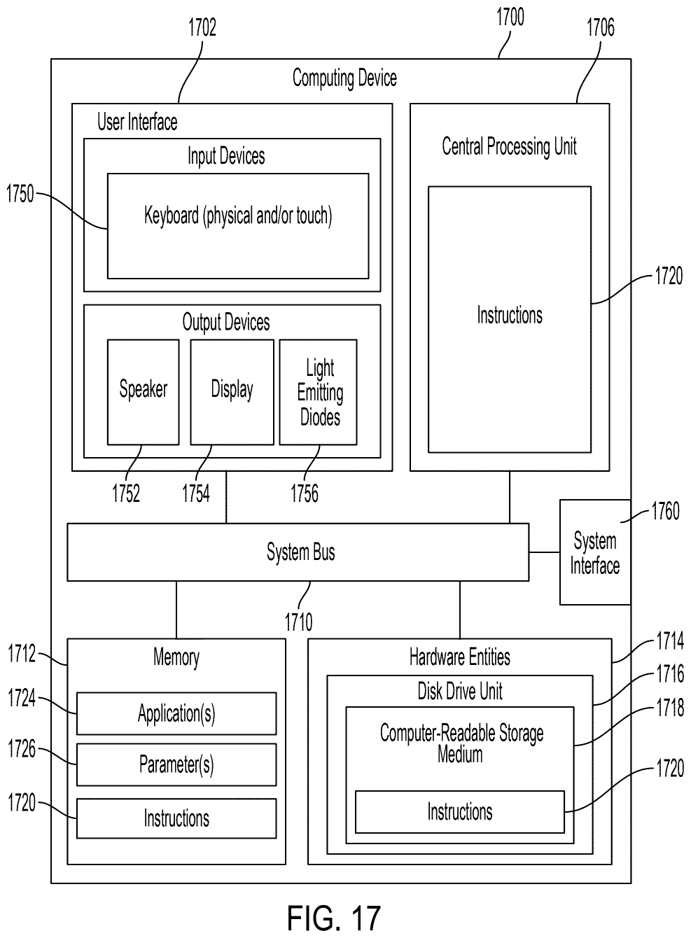

Referring now to FIG. 17, there is provided an illustration of an illustrative architecture for a computing device 1700. The controller 106 of FIG. 1 and/or controller 152 of FIG. 1 is/are the same as or similar to computing device 1700. As such, the discussion of computing device 1700 is sufficient for understanding the controllers 106, 152 of FIG. 1.

Computing device 1700 may include more or less components than those shown in FIG. 17. However, the components shown are sufficient to disclose an illustrative solution implementing the present solution. The hardware architecture of FIG. 17 represents one implementation of a representative computing device configured to operate a vehicle, as described herein. As such, the computing device 1700 of FIG. 17 implements at least a portion of the method(s) described herein.

Some or all components of the computing device 1700 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 17, the computing device 1700 comprises a user interface 1702, a Central Processing Unit (CPU) 1706, a system bus 1710, a memory 1712 connected to and accessible by other portions of computing device 1700 through system bus 810, a system interface 1760, and hardware entities 1714 connected to system bus 1710. The user interface can include input devices and output devices, which facilitate user-software interactions for controlling operations of the computing device 1700. The input devices include, but are not limited to, a physical and/or touch keyboard 1750. The input devices can be connected to the computing device 1700 via a wired or wireless connection (e.g., a Bluetooth® connection). The output devices include, but are not limited to, a speaker 1752, a display 1754, and/or light emitting diodes 1756. System interface 1760 is configured to facilitate wired or wireless communications to and from external devices (e.g., network nodes such as access points, etc.).

At least some of the hardware entities 1714 perform actions involving access to and use of memory 1712, which can be a Random Access Memory (RAM), a disk drive, flash memory, a Compact Disc Read Only Memory (CD-ROM) and/or another hardware device that is capable of storing instructions and data. Hardware entities 1714 can include a disk drive unit 1716 comprising a computer-readable storage medium 1718 on which is stored one or more sets of instructions 1720 (e.g., software code) configured to implement one or more of the methodologies, procedures, or functions described herein. The instructions 1720 can also reside, completely or at least partially, within the memory 1712 and/or within the CPU 1706 during execution thereof by the computing device 1700. The memory 1712 and the CPU 1706 also can constitute machine-readable media. The term “machine-readable media”, as used here, refers to a single medium or multiple media (e.g., a centralized or distributed database, and/or associated caches and servers) that store the one or more sets of instructions 1720. The term “machine-readable media”, as used here, also refers to any medium that is capable of storing, encoding or carrying a set of instructions 1720 for execution by the computing device 1700 and that cause the computing device 1700 to perform any one or more of the methodologies of the present disclosure.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with a particular implementation is included in at least one embodiment. Thus, discussions of the features and advantages, and similar language, throughout the specification may, but do not necessarily, refer to the same embodiment.

Furthermore, the described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

Without excluding further possible embodiments, certain example embodiments are summarized in the following clauses:

### Clause 1

A mobile platform, comprising: a chassis which extends in a longitudinal direction from a back end to a front end and extends in lateral directions from a platform centerline to two opposing lateral sides, the chassis comprising a plurality of body parts configured to rotate relative to each other; a plurality of limbs coupled to the chassis, each limb of said limbs comprising an upper limb member, a lower limb member, a first mechanical joint provided at a first point of articulation between the chassis and the upper limb member, and a second mechanical joint provided at a second point of articulation where the upper limb member meets the lower limb member; and a plurality of wheels connected to the plurality of limbs; wherein each said lower limb member has a first wheel connected to a first end thereof and a second wheel connected to an opposing second end thereof; and wherein the second mechanical joint is located between the first and second wheels

### Clause 2

The mobile platform according to Clause 1, further comprising a rotary joint provided between a first body part of the plurality of body parts and a second body part of the plurality of body parts.

### Clause 3

The mobile platform according to any preceding clause, wherein the rotary joint is configured to allow the plurality of body parts to passively rotate relative to each other.

### Clause 4

The mobile platform according to any preceding clause, wherein the plurality of body parts comprises a front body part, a back body part and a center body part rotatably coupled between the front and back body parts.

### Clause 5

The mobile platform according to any preceding clause, wherein each of the plurality of body parts rotates around a center axis that extends from the back end of the chassis to the front end of the chassis.

### Clause 6

The mobile platform according to any preceding clause, wherein the plurality of body parts are configured to rotate in the same direction and different directions relative to each other at any given time.

### Clause 7

The mobile platform according to any preceding clause, wherein a first limb and a second limb are coupled to the front end of the chassis on opposing sides of the mobile platform, and a third limb and a fourth limb are coupled to the back end of the chassis on the opposing sides of the mobile platform.

### Clause 8

The mobile platform according to any preceding clause, wherein the first mechanical joint rotates about a first axis and the second mechanical joint rotates about a second axis that is parallel to the first axis.

### Clause 9

The mobile platform according to any preceding clause, wherein the second mechanical joint is located midway between the first and second wheels.

### Clause 10

The mobile platform according to any preceding clause, further comprising: at least one wheel actuator configured to actuate the first and second wheels; wherein actuation of the first wheel is performed independent of actuation of the second wheel, or actuation of the first and second wheels.

### Clause 11

The mobile platform according to any preceding clause, further comprising at least one wheel actuator configured to actuate the first and second wheels simultaneously as a pair of wheels.

### Clause 12

The mobile platform according to any preceding clause, further comprising a track configured to be interchanged with the first and second wheels.

### Clause 13

The mobile platform according to any preceding clause, further comprising a tread configured to be installed on the first and second wheels.

### Clause 14

The mobile platform according to any preceding clause, further comprising a control circuit configured to selectively transition an operational mode of the mobile platform based on sensed conditions or characteristics of a surrounding environment.

### Clause 15

The mobile platform according to any preceding clause, wherein the operational modes comprise a road driving mode, an off-road driving mode, a wheel tumbling mode, a walking mode, and a climbing mode.

### Clause 16

The mobile platform according to any preceding clause, further comprising a control circuit configured to cause the mobile platform to turn by: rotating the first and second mechanical joints such that an outermost wheel of the first and second wheels of each limb is raised off the ground and an innermost wheel of the first and second wheels of each limb remains in contact with the ground; and simultaneously actuating the innermost wheels on a first side of the mobile platform and actuating the innermost wheels on a second side of the mobile platform in opposite directions or in the same direction at different speeds.

### Clause 17

The mobile platform according to any preceding clause, further comprising a control circuit configured to cause the mobile platform to turn by: rotating the first and second mechanical joints such that an outermost wheel of the first and second wheels of each limb is raised off the ground and an innermost wheel of the first and second wheels of each limb remains in contact with the ground; and actuating only one of the innermost wheels.

### Clause 18

The mobile platform according to any preceding clause, further comprising actuating the first and second mechanical joints of each said limb to cause the mobile platform to move forwards or backwards over hilly or uneven terrain while maintaining a central axis of the chassis aligned and parallel with a reference line that extends parallel to an x-axis and has a constant value n on a y-axis.

### Clause 19

The mobile platform according to any preceding clause, further comprising a control circuit configured to place the mobile platform in a certain position by actuating the first and second mechanical joints of each limb such that one of the first and second wheels is raised off the ground and another one of the first and second wheels remains in contact with the ground, and cause the mobile platform to travel along a path while the mobile platform is in the certain position.

### Clause 20

The mobile platform according to any preceding clause, further comprising actuating the second mechanical joint to cause the lower limb member to rotate more than 180° or 360° relative to the upper limb member.

### Clause 21

A method for controlling a mobile platform, comprising: causing, by a circuit, the mobile platform to traverse terrain; allowing rotation of a plurality of body parts of the chassis as the mobile platform traverses the terrain, the chassis extending in a longitudinal direction from a back end to a front end and extending in lateral directions from a platform centerline to two opposing lateral sides; actuating, by the circuit, a first mechanical joint provided at a first point of articulation between the chassis and an upper limb member of a limb of a plurality of limbs coupled to the chassis; actuating, by the circuit, a second mechanical joint provided at a second point of articulation where the upper limb member meets a lower limb member of the limb; wherein said causing comprises actuating at least one of a first wheel connected to a first end of the lower limb member and a second wheel connected to an opposing second end of the lower limb member; and wherein the second mechanical joint is located between the first and second wheels.

### Clause 22

The method according to Clause 21, further comprising actuating a rotary joint provided between a first body part of the plurality of body parts and a second body part of the plurality of body parts.

### Clause 23

The method according to any preceding method clause, wherein said rotation of the plurality of body parts is passive.

### Clause 24

The method according to any preceding method clause, wherein the plurality of body parts comprises a front body part, a back body part and a center body part rotatably coupled between the front and back body parts.

### Clause 26

The method according to any preceding method clause, wherein each of the plurality of body parts rotates around a center axis that extends from the back end of the chassis to the front end of the chassis.

### Clause 27

The method according to any preceding method clause, wherein the plurality of body parts are configured to rotate in the same direction and different directions relative to each other at any given time.

### Clause 28

The method according to any preceding method clause, wherein a first limb and a second limb are coupled to the front end of the chassis on opposing sides of the mobile platform, and a third limb and a fourth limb are coupled to the back end of the chassis on the opposing sides of the mobile platform.

### Clause 29

The method according to any preceding method clause, wherein the first mechanical joint rotates about a first axis and the second mechanical joint rotates about a second axis that is parallel to the first axis.

### Clause 30

The method according to any preceding method clause, wherein the second mechanical joint is located midway between the first and second wheels.

### Clause 31

The method according to any preceding method clause, wherein actuation of the first wheel is performed independent of actuation of the second wheel.

### Clause 32

The method according to any preceding method clause, wherein the first and second wheels are actuated simultaneously as a pair of wheels.

### Clause 33

The method according to any preceding method clause, further comprising interchanging a track with the first and second wheels.

### Clause 34

The method according to any preceding method clause, further comprising installing a tread on the first and second wheels.

### Clause 35

The method according to any preceding method clause, further comprising selectively transitioning an operational mode of the mobile platform based on sensed conditions or characteristics of a surrounding environment.

### Clause 36

The method according to any preceding method clause, wherein the operational modes comprise a road driving mode, an off-road driving mode, a wheel tumbling mode, a walking mode, and a climbing mode.

### Clause 37

The method according to any preceding method clause, further comprising causing the mobile platform to turn by: rotating the first and second mechanical joints such that an outermost wheel of the first and second wheels of each limb is raised off the ground and an innermost wheel of the first and second wheels of each limb remains in contact with the ground; and simultaneously actuating the innermost wheels on a first side of the mobile platform and actuating the innermost wheels on a second side of the mobile platform in opposite directions or in the same direction at different speeds.

### Clause 38

The method according to any preceding method clause, further comprising causing the mobile platform to turn by: rotating the first and second mechanical joints such that an outermost wheel of the first and second wheels of each limb is raised off the ground and an innermost wheel of the first and second wheels of each limb remains in contact with the ground; and actuating only one of the innermost wheels.

### Clause 39

The method according to any preceding method clause, further comprising actuating the first and second mechanical joints of each said limb to cause the mobile platform to move forwards or backwards over hilly or uneven terrain while maintaining a central axis of the chassis aligned and parallel with a reference line that extends parallel to an x-axis and has a constant value n on a y-axis.

### Clause 40

The method according to any preceding method clause, further comprising placing the mobile platform in a certain position by actuating the first and second mechanical joints of each limb such that one of the first and second wheels is raised off the ground and another one of the first and second wheels remains in contact with the ground, and cause the mobile platform to travel along a path while the mobile platform is in the certain position.

### Clause 41

The method according to any preceding method clause, further comprising actuating the second mechanical joint to cause the lower limb member to rotate more than 180° or 360° relative to the upper limb member.

The breadth and scope of this disclosure should not be limited by any of the above-described example embodiments, but should be defined only in accordance with the following claims and their equivalents.

We claim:

1. A mobile platform, comprising:
a chassis which extends in a longitudinal direction from a back end to a front end and extends in lateral directions from a platform centerline to two opposing lateral sides, the chassis comprising a plurality of body parts configured to rotate relative to each other;
a plurality of limbs coupled to the chassis, each limb of said limbs comprising an upper limb member, a lower limb member, a first mechanical joint provided at a first point of articulation between the chassis and the upper limb member, and a second mechanical joint provided at a second point of articulation where the upper limb member meets the lower limb member; and
a plurality of wheels connected to the plurality of limbs;
wherein each said lower limb member has a first wheel connected to a first end thereof and a second wheel connected to an opposing second end thereof; and
wherein the second mechanical joint is located between the first and second wheels.

2. The mobile platform according to claim 1, further comprising a rotary joint provided between a first body part of the plurality of body parts and a second body part of the plurality of body parts.

3. The mobile platform according to claim 1, wherein the rotary joint is configured to allow the plurality of body parts to passively rotate relative to each other.

4. The mobile platform according to claim 1, wherein the plurality of body parts comprises a front body part, a back body part and a center body part rotatably coupled between the front and back body parts.

5. The mobile platform according to claim 1, wherein each of the plurality of body parts rotates around a center axis that extends from the back end of the chassis to the front end of the chassis.

6. The mobile platform according to claim 1, wherein the plurality of body parts are configured to rotate in the same direction and different directions relative to each other at any given time.

7. The mobile platform according to claim 1, wherein a first limb and a second limb are coupled to the front end of the chassis on opposing sides of the mobile platform, and a third limb and a fourth limb are coupled to the back end of the chassis on the opposing sides of the mobile platform.

8. The mobile platform according to claim 1, wherein the first mechanical joint rotates about a first axis and the second mechanical joint rotates about a second axis that is parallel to the first axis.

9. The mobile platform according to claim 1, wherein the second mechanical joint is located midway between the first and second wheels.

10. The mobile platform according to claim 1, further comprising:
at least one wheel actuator configured to actuate the first and second wheels;
wherein actuation of the first wheel is performed independent of actuation of the second wheel, or actuation of the first and second wheels.

11. The mobile platform according to claim 1, further comprising at least one wheel actuator configured to actuate the first and second wheels simultaneously as a pair of wheels.

12. The mobile platform according to claim 1, further comprising a track configured to be interchanged with the first and second wheels.

13. The mobile platform according to claim 1, further comprising a tread configured to be installed on the first and second wheels.

14. The mobile platform according to claim 1, further comprising a control circuit configured to selectively transition an operational mode of the mobile platform based on sensed conditions or characteristics of a surrounding environment.

15. The mobile platform according to claim 14, wherein the operational modes comprise a road driving mode, an off-road driving mode, a wheel tumbling mode, a walking mode, and a climbing mode.

16. The mobile platform according to claim 1, further comprising a control circuit configured to cause the mobile platform to turn by:
rotating the first and second mechanical joints such that an outermost wheel of the first and second wheels of each limb is raised off the ground and an innermost wheel of the first and second wheels of each limb remains in contact with the ground; and
simultaneously actuating the innermost wheels on a first side of the mobile platform and actuating the innermost wheels on a second side of the mobile platform in opposite directions or in the same direction at different speeds.

17. The mobile platform according to claim 1, further comprising a control circuit configured to cause the mobile platform to turn by:
rotating the first and second mechanical joints such that an outermost wheel of the first and second wheels of each limb is raised off the ground and an innermost wheel of the first and second wheels of each limb remains in contact with the ground; and
actuating only one of the innermost wheels.

18. The mobile platform according to claim 1, further comprising actuating the first and second mechanical joints of each said limb to cause the mobile platform to move forwards or backwards over hilly or uneven terrain while maintaining a central axis of the chassis aligned and parallel with a reference line that extends parallel to an x-axis and has a constant value n on a y-axis.

19. The mobile platform according to claim 1, further comprising a control circuit configured to place the mobile platform in a certain position by actuating the first and second mechanical joints of each limb such that one of the first and second wheels is raised off the ground and another one of the first and second wheels remains in contact with the ground, and cause the mobile platform to travel along a path while the mobile platform is in the certain position.

20. The mobile platform according to claim 1, further comprising actuating the second mechanical joint to cause the lower limb member to rotate more than 180° or 360° relative to the upper limb member.

21. A method for controlling a mobile platform, comprising:
causing, by a circuit, the mobile platform to traverse terrain;
allowing rotation of a plurality of body parts of the chassis as the mobile platform traverses the terrain, the chassis extending in a longitudinal direction from a back end to a front end and extending in lateral directions from a platform centerline to two opposing lateral sides;
actuating, by the circuit, a first mechanical joint provided at a first point of articulation between the chassis and an upper limb member of a limb of a plurality of limbs coupled to the chassis;
actuating, by the circuit, a second mechanical joint provided at a second point of articulation where the upper limb member meets a lower limb member of the limb; and
wherein said causing comprises actuating at least one of a first wheel connected to a first end of the lower limb member and a second wheel connected to an opposing second end of the lower limb member;
wherein the second mechanical joint is located between the first and second wheels.
